(19) United States
(12) Patent Application Publication
(10) Pub. No.: US 2021/0237418 A1
(43) Pub. Date: Aug. 5, 2021

(54) METHOD FOR PRODUCING PRINTED NONWOVEN-FILM LAMINATES

(71) Applicant: RKW SE, Frankenthal (DE)

(72) Inventor: Ludwig Börmann, Babensham (DE)

(21) Appl. No.: 17/049,679

(22) PCT Filed: Apr. 17, 2019
(86) PCT No.: PCT/EP2019/059949

§ 371 Date: Oct. 22, 2020

(30) Foreign Application Priority Data
Apr. 24, 2018 (EP) 18169085.0

(51) Int. Cl. B32B 37/06; B32B 5/02; B32B 27/32; B32B 7/12; B32B 37/08; B32B 27/20; B32B 37/00

(52) U.S. Cl. CPC B32B 37/06; B32B 5/022; B32B 27/32; B32B 7/12; B32B 2307/4023; B32B 27/205; B32B 37/0053; B32B 2262/0253; B32B 2274/00; B32B 37/08

(57) ABSTRACT

The invention relates to a method for producing a printed nonwoven film laminate from a starting film web of a thermoplastic polymer material and a starting nonwoven web, wherein the melting point of the starting nonwoven web is above the crystallite melting point of at least one component of the polymer material of the starting film web. The method includes at least partially coating the starting film web with a printing ink and with an adhesion promoter; heating the coated film web together with the starting nonwoven web to a temperature which is above the crystallite melting point of the at least one component of the polymer material of the starting film web and of the adhesion promoter and below the crystallite melting point of the starting nonwoven web, to obtain a laminate; and cooling the laminate obtained through a cooled roller nip. Furthermore, the invention relates to printed nonwoven film laminates produced by the method and their use.

The invention relates to methods for production of printed nonwoven film laminates, printed nonwoven film laminates produced therewith, and their use, especially in the hygiene area, e.g. in diapers.

From EP 0 768 168 A1 and EP 1 716 830 A1, methods for producing films that can be used in the hygiene area are known. Due to their application area, several requirements are placed on such hygiene films. These should be impervious to liquids and have certain haptic properties, such as softness, suppleness, low rustling behavior and a textile feel. Films in the hygienic area should have a soft, fabric-like feel. Particularly when they are used for incontinence products, the development of noise should be as low as possible, i.e. the films should have little rustle. In conjunction with a low degree of gloss, this results in a very textile film, being desirable in the hygiene area. In addition, the absorbent bodies contained in diapers and incontinence products have become increasingly thinner in recent years, which has been made possible particularly by use of superabsorber polymers. These superabsorber polymers are used in the form of coarse-grained powders, and the hygiene films are required to have such a strength that a puncturing of the film by the individual grains, e.g. at stress by sitting down or other movement of the wearer, is avoided with certainty. The formation of holes (“pinholes”) by superabsorber polymers and the bursting of the ready-made film products in the packaging units must be avoided. Another requirement for hygienic films is a minimum tensile strength being required for processing the film webs on the high-speed machines (converters) of the manufacturers of e.g. diapers and sanitary napkins. In addition, films for hygienic applications should have a certain longitudinal and transverse tear strength.

Laminates made of film and nonwoven, said laminates being used in the hygiene area, are also known. Production of such laminates is described in WO 2006/024394 A1, wherein a starting film web of thermoplastic polymer material together with a starting nonwoven web, whose melting point is above the crystallite melting point of the polymer material, are heated to a temperature above the crystallite melting point of the polymer material and below the melting point of the starting nonwoven web, and the laminate formed is passed through a cooled roller nip and is thereby cooled to a temperature below the crystallite melting point of the starting film web.

In EP 0 768 168 A1, a starting film web made of thermoplastic polymer material is heated to the molten liquid state of the polymer material and then passed through a cooled roller nip. In EP 1 716 830 A1, a process of heating of the polymer material and subsequent passing through a cooled roller nip is carried out using a starting film web containing a thermoplastic polymer material having a polyethylene matrix, in which 1 to 70 parts by weight of polypropylene, based on 100 parts by weight of the polyethylene matrix, are included. In this, the starting film web is heated up to the molten liquid state of the polyethylene matrix material but not up to the molten liquid state of the polypropylene. There are described films having a thickness of down to 15 μm, which films still meet the requirements for hygienic films. Even thinner films are known from EP 2 565 013 A1, said films being produced by a special stretching process, wherein films made of thermoplastic polymer material containing a low-melting component and a high-melting component are heavily stretched by heating into the partially molten state.

Nonwoven film laminates increasingly become printed. WO 2006/024394 A1 describes the printing of films using printing inks, before the film is bonded to the nonwoven. As long as the printing ink covers a small part of the film only, that is usually 5 to 10%, the bond between film and nonwoven produced by thermo-lamination after application of the printing ink is not affected, since the non-printed areas provide a sufficient bond. However, since the market development goes into direction of increasing coverage by printing ink, up to complete coverage, there arises the problem that there is no bond between film and nonwoven at the places where the films are printed, and therefore a laminate can no longer be produced using the known thermo-lamination process at higher printing ink coverages.

The invention is based on the object of solving this problem and of enabling the production of nonwoven film laminates even at high printing ink coverages.

This problem is solved in that a printed film of thermoplastic polymer material is coated (printed) with an adhesion promoter at the printed places and subsequently is heated, together with a nonwoven web, into the molten liquid state of at least one polymer component of the film and the adhesion promoter, which lie below the crystallite melting point of the nonwoven. The laminate obtained is then cooled in a cooled roller nip. In contrast to conventional hot melt adhesives or hotmelts that are applied in the hot or molten state to a polymer film, in the method according to the invention the adhesion promoter is applied at lower temperatures, preferably in solvent-based or water-based form, in particular by means of a printing unit, or in one embodiment said adhesion promoter is already added to the printing ink and then is applied together with the printing ink. After application, the adhesion promoter is converted into its molten liquid state by heating the film and the nonwoven, thereby creating the bond between the film and the nonwoven at the printed places.

The invention thus relates to a method for producing a printed nonwoven film laminate from a starting film web of a thermoplastic polymer material and a starting nonwoven web, the melting point of the starting nonwoven web being above the crystallite melting point of at least one component of the polymer material of the starting film web, the method comprising the following steps: at least partially coating the starting film web of the thermoplastic polymer material with a printing ink and with an adhesion promoter; heating the coated starting film web together with the starting nonwoven web to a temperature which is above the crystallite melting point of the at least one component of the polymer material of the starting film web and of the adhesion promoter and is below the crystalline melting point of the starting nonwoven web, in order to obtain a laminate; and cooling the resulting laminate through a cooled roller nip.

A suitable starting film web contains at least one polymer component or a polymer material, whose melting point is below the crystallite melting point of the starting nonwoven web. In a preferred embodiment of the method, a starting film web having a low-melting polymer component and a high-melting polymer component is used, for example having 15 to 85% by weight of low-melting polymer component and 85 to 15% by weight of high-melting polymer component, based on 100% by weight of low-melting and high-melting polymer components. Preferably, a starting film web having at least one polypropylene as the low-melting polymer component and at least one polypropylene as the high-melting polymer component is used. In addition, a starting film web having at least one polyethylene as the low-melting polymer component and at least one polyethylene as the high-melting polymer component can be used. For example, a starting film web and a starting nonwoven web each having at least one polyethylene or at least one polypropylene can be used.

In further preferred embodiments of the method, the starting nonwoven web contains fibers based on polyethylene and/or polypropylene.

Preferably, at least 10%, in particular at least 15%, preferably at least 20%, of the starting film web is coated with the printing ink and with the adhesion promoter. The printing ink is preferably a printing ink which, for example, contains pigments, binders and solvents. The printing ink is either water-based or solvent-based, in particular it is water-based or ethanol-based. The adhesion promoter preferably is a thermoplastic polymer based on water or solvent. In particular, said adhesion promoter includes ethylene-vinyl acetate copolymer (EVA copolymer) or polyamide as a polymer. In particularly preferred embodiments, there is used a printing ink which contains the adhesion promoter. This enables that printing ink and adhesion promoter can be applied in one step.

In further embodiments of the invention, a starting film web is used, which contains 1 to 75% by weight, in particular 50 to 75% by weight, of filler, in particular of chalk. The production of breathable laminates is enabled thereby.

In further preferred embodiments of the method, the heating takes place to 5 to 20° C. below the crystallite melting point of the starting nonwoven web. Furthermore, the laminate is preferably subjected to cooling in the cooled roller nip to at least 10 to 30° C. below the crystallite melting point of the at least one component of the polymer material of the starting film web. Prior to printing, the starting film web can have been stretched in machine direction, or cross (transverse) direction, or in machine and cross directions. When using filled films, breathable films can be produced by this stretching, said breathable films being further processed into breathable laminates.

The invention also relates to printed nonwoven film laminates which are produced using the method according to the invention. For example, the printed laminates can have a basis weight of 10 to 45 g/m², particularly of 10 to 35 g/m², preferably of 10 to 25 g/m². The invention further relates to the use of the printed laminates, particularly in the hygiene or medical area, for example for backsheets in diapers, for bed liners, or sanitary towels.

Preferred embodiments of the invention are described in the description hereinafter, in the figures and in the claims.

The figures show the following:

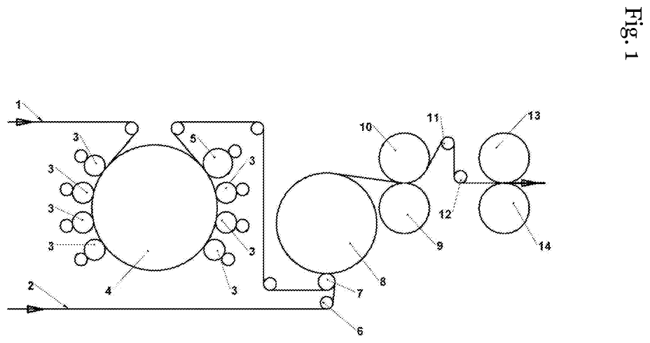

FIG. 1 shows a preferred embodiment for carrying out the method according to the invention, wherein the system used has eight printing units.

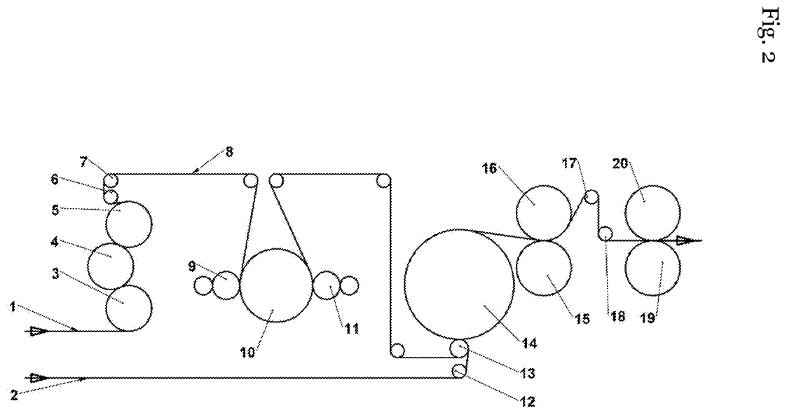

FIG. 2 shows a preferred embodiment for carrying out the method according to the invention, wherein the system used has a stretching unit and two printing units.

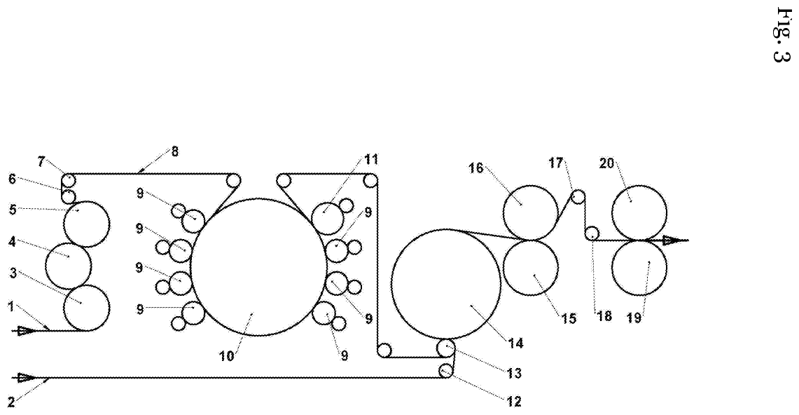

FIG. 3 shows a preferred embodiment for carrying out the method according to the invention, wherein the system used has a stretching unit and eight printing units.

The method of the invention enables the production of thin, printed, breathable or non-breathable nonwoven film laminates, said laminates meeting the requirements for films in the hygiene area. For example, depending on the thickness of the film and the nonwoven, printed laminates having a basis weight of less than 16 g/m², e.g. 14 g/m² or 12 g/m² or 10 g/m² can be produced in a stable process. Such laminates can be further processed inline as so-called backsheets with a textile handle (textile backsheets) for diapers. Another advantage of the laminates obtained by the method of the invention resides in improved thermal stability due to use of the high-melting polymer component, e.g. of polypropylene. For example, when using the laminates as backsheets in the hygiene area, the application of the interior of, for example, baby diapers or incontinence articles by means of hotmelt adhesive systems is enabled at temperatures in the range of from 140 to 160° C., without the thin laminate being melted. The invention enables the production of nonwoven film laminates having any size of printing ink coverages.

In the present invention, the indicated melting points, melting ranges, and crystallite melting points relate to a determination according to DSC (differential scanning calorimetry).

According to the invention, the melting point of the starting nonwoven web is above the crystallite melting point of at least one component of the polymer material of the starting film web or above the crystalline melting point of at least one polymer material of the starting film web. Suitable starting film webs contain at least one polymer component, whose melting point is below the crystallite melting point of the starting nonwoven web. In the method of the invention, the at least one polymer component is heated into the molten liquid state. The starting film web contains preferably at least one low-melting polymer component and at least one high-melting polymer component. Preferably, the starting film web contains one, preferably two, low-melting polymer component(s). Preferably, the starting film web contains one, particularly two, high-melting polymer component(s). When the method is carried out, the molten liquid polymer materials of the starting film web are assigned to the low-melting polymer component, and the non-molten liquid polymer materials of the starting film web are assigned to the high-melting polymer component.

It is known that polymers do not have a sharply defined melting point but a melting range, although a crystalline melting point can be assigned to the crystalline areas of a polymer. This crystalline melting point always is higher than the melting point or melting range of the non-crystalline components. The molten liquid state is described by the shear modulus as approaching zero. In case of polymers having crystalline areas, the latter are no longer detectable. The shear modulus can be determined, for example, according to ISO 6721-1 & 2. In the present invention, the starting film web is heated to a temperature, at which the shear modulus of at least one polymer component is zero. If the starting film web contains a low-melting polymer component and a high-melting polymer component, the shear modulus for the low-melting polymer component is zero and the shear modulus for the high-melting polymer component is not zero. In this case, for the low-melting polymer component crystalline areas are no longer detectable, and the low-melting polymer component is in the molten liquid state. On the other hand, for the high-melting polymer component crystalline areas are still detectable and this polymer component is below the molten liquid state.

In principle, all thermoplastic polymers that have corresponding melting points can be used as materials for the starting film web. For this purpose, numerous commercial products are available on the market. Preferably, various polyolefins, particularly polyethylenes, polypropylenes, copolymers of ethylene and propylene, copolymers of ethylene and propylene with other comonomers, or mixtures thereof, are used. Furthermore, ethylene vinyl acetate (EVA), ethylene acrylate (EA), ethylene ethyl acrylate (EEA), ethylene acrylic acid (EAA), ethylene methyl acrylate (EMA), ethylene butyl acrylate (EBA), polyester (PET), polyamide (PA), e.g. nylon, ethylene vinyl alcohols (EVOH), polystyrene (PS), polyurethane (PU), or thermoplastic olefin elastomers are suitable.

In order to ensure a bond between film and nonwoven, the starting film web contains at least one polymer component which is in the molten liquid state in the method of the invention, and is compatible with the starting nonwoven web. In particular, the starting film web contains at least one polypropylene, and the starting nonwoven web also contains at least one polypropylene.

The total amount of low-melting polymer component is preferably 90 to 10% by weight, in particular 80 to 20% by weight, most preferably 70 to 30% by weight, and the total amount of high-melting polymer component is preferably 10 to 90% by weight, in particular 20 to 80% by weight, most preferably 30 to 70% by weight, in each case based on 100% by weight of low-melting and high-melting polymer components. Alternatively, the total amount of low-melting polymer component is preferably 85 to 15% by weight, and the total amount of high-melting polymer component is 15 to 85% by weight, again based on 100% by weight of low-melting and high-melting components. These quantities can refer, for example, to one or more polypropylene(s) and one or more polyethylene(s) for the low-melting polymer component, and to one or more polypropylene(s) for the high-melting polymer component.

In a particularly preferred embodiment, the starting film web contains at least one polypropylene as the low-melting polymer component and at least one polypropylene as the high-melting polymer component.

Preferably, the low-melting polymer component contains ethylene copolymers, in particular propylene-ethylene copolymers, or consists of these. Furthermore, the low-melting polymer component can contain ethylene polymers, such as LDPE (low density polyethylene), LLDPE (linear low density polyethylene), MDPE (medium density polyethylene) and HDPE (high density polyethylene). Other preferred comonomers are other olefins, such as butene, hexene, or octene. The ethylene copolymers, particularly propylene-ethylene copolymers, can also contain other thermoplastic polymers. Preferably, the low-melting polymer component contains a polypropylene. It is known that there exist highly crystalline isotactic polypropylene, less crystalline syndiotactic polypropylene, and amorphous atactic polypropylene, which have different melting points, melting ranges, or crystalline melting points. In case of using amorphous atactic polypropylene having a significantly lower melting point or melting range than isotactic polypropylene and optionally also syndiotactic polypropylene, depending on the heating temperature used in the method according to the invention, said polypropylene possibly would have to be assigned to the low-melting polymer component.

Preferably, the high-melting polymer component contains at least one polypropylene, whose melting point, melting range, or crystallite melting point is significantly higher than that of the low-melting polymer component. Suitable polypropylene particularly is isotactic polypropylene. Syndiotactic polypropylene also can be used, provided its melting point, melting range, or crystallite melting point is significantly higher than that of the low-melting polymer component. Suitable polypropylenes are commercially available, for example, for the production of blown and/or cast films.

The high-melting point polymer component can comprise both propylene homopolymers and propylene copolymers with propylene as the main monomer. Suitable comonomers for propylene copolymers are olefins other than propylene, preferably ethylene. The ethylene content in the propylene-ethylene copolymers is preferably 2 to 30% by weight, particularly preferably 2 to 20% by weight, and in particular 2 to 15% by weight or 3 to 20% by weight.

The melting ranges for some polyethylenes and polypropylenes are indicated below:

### LDPE: 110-114° C.;

### LLDPE: 115-130° C.;

### HDPE: 125-135° C.;

Propylene homopolymers: 150-165° C.;
Propylene-ethylene copolymers: 120-162° C., when containing very little amounts of ethylene, higher temperatures are also possible;
Bimodal propylene-ethylene (homo) copolymers: 110-165° C.

It is also possible to use so-called bimodal polypropylenes. These are two different polypropylenes, each having a different proportion of copolymer, being combined in a single raw material. Such a bimodal polypropylene has two crystalline melting points, wherein the approximate proportions of the two polypropylenes can normally also be determined via DSC analysis. An example is a bimodal polypropylene having crystallite melting points of 125° C. and 143° C., the proportion of the two different polypropylenes being 25/75. In case of a heating temperature of 130° C., the proportion of 25% of polypropylene having a crystalline melting point of 125° C. would be assigned to the low-melting polymer component, and the proportion of 75% polypropylene having a crystalline melting point of 143° C. would be assigned to the high-melting polymer component.

In the method of the invention, the heating of the starting film web together with the nonwoven web is carried out up to or above the molten liquid state of at least one component of the polymer material of the starting film web and below the molten liquid state of the starting nonwoven web. Herein, up to the molten liquid state means that at least one polymer material or at least one polymer component of the starting film web is in the molten liquid state. However, it is heated merely that high that the starting nonwoven web is not in the molten liquid state. The starting film web is thus heated at least up to its partially molten liquid state, while the starting nonwoven web is not melted on.

Just as special molten polypropylene can be present in the low-melting polymer component, a special non-molten polyethylene can also be present in the high-melting polymer component, the latter then being assigned to the high-melting polymer component. Preferably, the high-melting polymer component contains at least one polypropylene.

In order to enable a stable process management over a longer time period, the (crystallite) melting points of the low-melting and high-melting polymer components of the starting film web should appropriately be not too close to each other. Preferably, the crystalline melting point of the low-melting polymer component or, if several low-melting polymer components are present, the crystalline melting point of that component having the highest crystalline melting point thereof, is at least about 5° C., preferably at least about 10° C., and in particular at least about 20° C., below the crystallite melting point or the molten liquid state of the high-melting polymer component or, if several high-melting polymer components are present, that component having the lowest crystalline melting point thereof.

The method according to the invention also enables the production of breathable laminates. In this case, the starting films additionally contain fillers and are subjected to a stretching process before printing and heating, wherein pores can form at the fillers. Suitable fillers are not subject to any restrictions and are known to the person skilled in the art. Suitable are all materials that can be ground to a certain size, do not melt in the extruder, and cannot be stretched. Inorganic fillers, such as chalk (calcium carbonate), clay, kaolin, calcium sulfate (gypsum), or magnesium oxide are particularly suitable. In addition, synthetic fillers, such as carbon fibers, cellulose derivatives, ground plastics or elastomers are also suitable. Calcium carbonate or chalk is most preferred, because of its low price but also in view of sustainability. The filler can have a particle size of, e.g. 0.8 to 2 μm. If a filler having a more uniform particle size than chalk is desired, it is also possible to use synthetic fillers having a uniform particle size or particle size distribution. The film may contain little fillers, e.g. 5 to 45% by weight, or 10 to 50% by weight, so that pores will form during a stretching process, but these pores are isolated, and the film is not breathable. In order to achieve breathability of the film, appropriately at least 35% by weight of filler, in particular at least 45% by weight of filler, preferably at least 55% by weight of filler, more preferably at least 65% by weight of filler, based on 100% by weight of the total formulation of the starting film web, including filler(s), are used. The upper limit of filler is determined in that no longer pores but holes are created, or in that the film tears. Suitable film formulations having filler can be routinely determined by a person skilled in the art. A formulation with 35 to 75% by weight, in particular 45 to 75% by weight, preferably 55 to 70% by weight, of filler, based on 100% by weight of the starting film web, is particularly suitable. Exemplary formulations for non-breathable films comprise 5 to 50% by weight, particularly 10 to 40% by weight, of fillers, based on 100% by weight of the starting film web. Exemplary formulations for breathable films comprise 35 to 80% by weight, in particular 45 to 75% by weight, of fillers, based on 100% by weight of the starting film web. Attention is given that the proportion of the low-melting component is selected not that high that breathability is indeed achieved but this breathability is lost again because of re-closing of the pores.

The starting film webs for carrying out the method of the invention can be produced by any method known in the art. For example, the starting film web can be produced by heating the polymer components, and optionally fillers, in an extruder, e.g. a compounding extruder, up to a temperature well above the melt flow temperature of the polymer components (e.g. more than 200° C.) and melting same. This is followed by a cast process (casting process), e.g. via a slot die, or a blow molding process. These methods are known in the art. A film is extruded through a slot die in the slot die process. The blow molding process, in which a blow tube is formed, is preferred. The tubular film formed can be laid flat on top of each other and slit open or separated at the ends, so that two film webs are formed.

In preferred embodiments, the starting film web is stretched in machine direction (MD), cross (transverse) direction (CD), or in both machine and cross directions, before printing. An elongation, drawing or stretching of a film means stretching the film in an indicated direction resulting in a reduction of the film thickness. The film can be stretched in machine or longitudinal direction (MD), for example, by a stretching unit which comprises two or more rollers, e.g. three rollers that are driven at different velocities. The film can, for example, be stretched at a stretching ratio of 1:1.5, which means that a film thickness of e.g. 15 μm is reduced to 10 μm. It is also possible to subject the film web additionally to cross stretching (CD). Such biaxial stretching can, for example, be achieved by stretching machines available on the market, e.g. from the Bruckner company. The stretching ratio used depends on the film formulation and the selected process parameters, and can be at least 1:1.2, preferably at least 1:1.5, in particular at least 1:2, more preferably at least 1:2.5, more preferably at least 1:3 or at least 1:4.

The starting film web can be single-layered, that is, mono-extruded. It can be multi-layered, which means that it is co-extruded. There is no restriction regarding the number of layers used. There may be one or more layers, e.g. one layer, two layers, three layers, or four layers. Also possible are e.g. up to 5, 7 or 9 layers. The layers can have the same or different formulations, wherein the assignment to the low-melting or high-melting polymer component is determined in each case by the crystallite melting point. The layers of a starting film web can be produced by coextrusion, wherein there is no restriction regarding the number of coextruded layers of a starting film web. In case of multi-layered starting film webs, at least one layer can be produced by blow molding extrusion and at least one other layer can be produced by cast extrusion.

There is no restriction on the combination of blow-extruded and/or cast-extruded films or film layers. There is no restriction regarding the number of coextruded layers. In further embodiments, the starting film web is not coextruded.

In exemplary embodiments, the starting film web can also be produced as described hereinafter:
blow-extruded, slit, on two separate webs and separate rolls, respectively;
blow-extruded, slit, on two or more separate webs at the same time;
blow-extruded, slit, laid flat as an unseparated tube;
blow-extruded, slit into two or more separate webs coming from different extruders; or
cast-extruded into two or more separate webs at the same time.

It is also possible to produce the starting film webs inline. In this case, there is a production step for the extrusion and stretching processes (MDO, biaxial or ring rolling) as well as printing.

The starting film webs used in the method of the invention can be colored, e.g. white using titanium dioxide. Furthermore, the starting film webs may contain conventional additives and processing aids. In particular, apart from the fillers already mentioned, this concerns pigments or other coloring substances, non-stick agents, lubricants, processing aids, antistatic agents, germ-preventing agents (biocides), antioxidants, heat stabilizers, stabilizers against UV light, or other agents for modifying properties. Such substances as well as fillers are typically added to the starting film web prior to the heating according to the invention, e.g. during their production in the polymer melt or before extrusion into a film.

Preferably, the starting film web has basis weights in the range below 50 g/m², in particular below 40 g/m², preferably below 30 g/m², more preferably below 20 g/m². Basis weights in the range below 10 g/m² or below 5 g/m² are also possible. Preferred basis weights are within the range of from 1 to 30 g/m², 1 to 25 g/m² or 1 to 20 g/m², in particular from 1 to 15 g/m², more preferred from 2 to 10 g/m² or 7 to 20 g/m². The basis weights also can be 1 to 10 g/m², 5 to 10 g/m² or 5 to 15 g/m². The starting film web can have thicknesses within the range of from 2 to 30 μm, in particular from 2 to 15 μm, from 5 to 20 μm, or from 5 to 10 μm.

The starting nonwoven web is also produced by any method known in the prior art and is not subject to any restrictions. Suitable are all nonwovens that contain at least one formulation component on basis of a thermoplastic polymer. The nonwovens can contain fibers of polyethylene (PE), polypropylene (PP), polyester (PET), polyamide (PA), rayon, cellulose, and mixtures of these fibers. Bi- or multi-component fibers also can be used. Particularly preferred e.g. nonwovens made of discontinuous or staple fibers based on PP, PE or PET, as well as nonwovens made of mixtures of PP and PE, or mixtures of PET and PP or PE, are used. Fibers based on PP, PE, or mixtures of PP and PE are most preferred. In order to ensure a bond between film and nonwoven, the starting nonwoven web appropriately contains at least one thermoplastic polymer component which has a similar morphology to a polymer component of the starting film web, for example polypropylene.

The starting nonwoven web has a melting point which is above the crystallite melting point of at least one polymer component of the starting film web, particularly of a low-melting polymer component of the starting film web. Similar to the starting film web, the nonwoven web can have at least one low-melting polymer component and at least one high-melting polymer component, in particular a low-melting polymer component and a high-melting polymer component. It is possible to use single-layered, double-layered or multi-layered nonwovens. In any case, it is required to ensure that at least one polymer component of the starting nonwoven web has a melting point above the crystallite melting point of at least one polymer component of the starting film web. In case of multi-layered nonwovens, this can be the nonwoven layer in contact with the film web. The starting nonwoven web is appropriately not melted on when carrying out the method according to the invention.

Preferably, the starting nonwoven web has basis weights within the range of from 4 to 35 g/m², in particular from 6 to 25 g/m², preferably from 8 to 15 g/m², more preferably from 8 to 14 g/m². Basis weights within the range of from 8 to 50 g/m² are also possible.

The method according to the invention can be carried out with all thermoplastic formulations for film and nonwoven, wherein the melting points meet the requirements of the method according to the invention. The raw materials of film and nonwoven and adhesion promoter are appropriately matched to each other in such a way that a sufficient bond between film and nonwoven is achieved, also depending on the printing ink coverage. Suitable combinations of materials are known to the person skilled in the art or can be determined by means of a few orienting experiments.

The starting film web is printed by using conventional methods. Depending on the number of colors to be printed, or the desired print motif, one or more printing units are used. In FIGS. 1 to 3, as examples, two-color and eight-color printing units are shown. Any desired printing ink coverage can be set using the printing units. Preferably, the printing ink coverage is at least 10%, at least 15%, preferably at least 20%. The upper limits for the printing ink coverage are preferably at most 100%, in particular at most 95%, preferably at most 90%. Preferred ranges for the printing ink coverage are from 15% to 100%, or from 15% to 95%, in particular from 20% to 100%, or from 20% to 95%. Ranges of from 25% to 85%, or 30% to 80%, or 30% to 70% are also possible.

In the present invention, the percentage of printing ink coverage is based on a film area of 10 m². This means that for a printing ink coverage of, for example, 25% on a film area of 10 m², 25% of this film area are covered by printing ink.

Suitable printing inks are not subject to any restrictions. Suitable are all printing inks known for plastic films are and any number of printing inks can be used. Suitable printing inks are commercially available. Exemplary printing inks contain pigments, and binders and/or solvents and, if appropriate, additives. The printing ink can be water-based, or solvent-based. Particularly, the printing ink is water-based or based on ethanol.

Thermoplastic polymers on water-basis or solvent-basis are suitable as adhesion promoters. Suitable adhesion promoters are known to the person skilled in the art, and are commercially available, for example, as water-based or solvent-based hot-melt adhesive for PE films or PP films, e.g. with the designation ADCOTE™ from Dow Chemical Company. Suitable basis polymers for the adhesion promoter are known, wherein preference is given to an ethylene-vinyl acetate copolymer (EVA copolymer), or polyamide. The adhesion promoter creates a bond between the printed film and the nonwoven. In the method according to the invention, unlike common hot melt adhesives that are applied or sprayed on in hot or molten liquid form, the adhesion promoter is applied in water-based or solvent-based form onto the printed places of the film, or is applied together with the printing ink to the film, for example, using a printing unit, and then the film and nonwoven are heated above the melting point of the adhesion promoter so that the adhesion promoter is in the molten liquid state, or at least one polymer component of the adhesion promoter is in the molten liquid state. The application of the adhesion promoter on water-basis or solvent-basis enables precise dosing.

In particularly preferred embodiments, a printing ink is used, which contains the adhesion promoter. In other preferred embodiments, the printing ink and the adhesion promoter are separately applied.

The adhesion promoter is appropriately applied using a printing unit, such as it is also used for applying the printing inks. Examples are shown in FIGS. 1 to 3. The adhesion promoter can be applied anywhere on the film. The adhesion promoter is appropriately applied to the printed areas of the film.

According to the invention, the starting film web and starting nonwoven web are together heated and then passed through a cooled roller nip. Preferably, the heating is carried out to 5 to 20° C., in particular to 10 to 20° C., below the crystallite melting point of the starting nonwoven web.

According to the invention the heating is performed by means of at least one heating roller. It is not relevant whether the starting film web or the starting nonwoven web rests on the heating cylinder. In a preferred embodiment, the starting nonwoven web is in direct contact with the heating cylinder surface, and the starting film web is passed over it. In another preferred embodiment, the starting film web is in direct contact with the heating cylinder surface, and the starting nonwoven web is passed over it. The heating is preferably carried out by means of one or more heating rollers, which are contact rollers that are heated to the predetermined temperature by means of a heat transfer medium, e.g. steam, water, oil. In a preferred embodiment, a single heating or contact roller is used. It is, however, also possible to use two or more heating rollers, in which case it is necessary to ensure that the molten liquid state of at least one polymer component of the starting film web is attained upstream of the cooled roller nip. In order to ensure that the starting film web does indeed attain the temperature of the heating roller or that, in case of high production velocities (where the surface temperature of the heating cylinder is higher than that of the films), the molten liquid state of one polymer component is attained with certainty, an adequate residence time of the starting film web on the heating roller surface must be ensured. This can be attained by an appropriate wrapping path of the heating cylinder, the diameter of the heating roller and/or the film web velocity as a function of the film thickness. It may be appropriate to use a heating roller with an anti-adhesion coated surface in order to permit easier detachment of the film web resting on the heating roller and thus prevent tearing-off of the film web. Thus, displacement of the detachment point in the direction of rotation of the heating roller is avoided, and no or only a small lead is necessary. For this purpose, a PTFE (polytetrafluoroethylene) coated heating roller is used, for example.

The invention is illustrated by the following example using a suitable formulation for film and nonwoven under suitable process conditions. If the starting nonwoven web used is based on a polypropylene and has a melting point in the range of from 160 to 165° C., a sufficient bond between film and nonwoven results in case that the polymer material of the starting film web has a polypropylene, as a bonding component, that is in the molten liquid state. As a rule, there would be not a sufficient bond, if only one polyethylene is in the molten liquid state. Applied to a starting film formulation having 35% by weight of LDPE (melting point 112° C.), 20% by weight of LLDPE-butene (melting point 121° C.), 10% by weight of polypropylene (melting point 162° C.), 30% by weight of random polypropylene copolymer (melting point 140° C.) and 5% by weight of TiO₂ white concentrate, color, and additives, this would mean that in the thermo-lamination process the LDPE, the LLDPE-butene and the random polypropylene copolymer (melting point 140° C.) are in the molten liquid state, but not the polypropylene (melting point 162° C.). That is, the heating roller, to which the nonwoven web is fed, must ensure a corresponding heating of the starting film web, such as to 142° C. or 143° C. At this temperature a sufficient bond of the film to the polypropylene nonwoven is achieved, and there is no risk of a melting on the surface of the nonwoven.

Heating of the webs may be supported with other heating methods, such as radiant heat, e.g. with infrared heating or infrared radiators. In addition to one or more heating rollers, a different heating, e.g. infrared heating, may be provided.

According to the invention, the laminate obtained is passed through a cooled roller nip after heating. The rollers forming the cooling roller nip are cooled in such a manner that rapid and sudden cooling is achieved. Cooling to a temperature below the crystallite melting point of the low-melting polymer component of the starting film web, preferably to at least 5° C. below, in particular to at least 10° C. below, is appropriate. Preferred cooling ranges are 5 to 10° C., more preferably 10 to 30° C., below the crystallite melting point of the low-melting polymer component of the starting film web. For example, the cooling of the rollers can be performed using water of a temperature range of 5 to 20° C., e.g. water at about 10° C. The distance between the heating roller or, if several heating rollers are used, the last heating roller and/or other heating sources and the cooled roller nip is selected such as to be not too large, because of possible heat losses. The cooling roller nip may be in the simplest case, for example, a smooth-roller nip having two smooth rollers. In the case of hygiene films, the roller nip is preferably formed by a pair of rollers with one texturing roller and one smooth roller, thereby imparting a textured surface to the film web. Preferred textures in the hygiene field are micro-textures, e.g. a truncated pyramid. Preferably, the cooled roller nip consists of a steel roller and a rubber roller operating under counter-pressure, the steel roller being provided with the textured surface.

Depending on the film parameters and other process conditions, the film web velocities are in the range of from 50 to 900 m/min. The velocity of the heating roller(s) is preferably 50 to 900 m/min, particularly 50 to 800 m/min, preferably 100 to 600 m/min. The velocity of the rollers forming the cooled roller nip is preferably 50 to 900 m/min, particularly 50 to 800 m/min, preferably 100 to 600 m/min.

The method according to the invention enables the production of nonwoven film laminates having low basis weights of e.g. 8, 9, 10, 11, 12, 13, 14, 15, 16, 17, 18, 19, 20, or 25 g/m². Preferred basis weight ranges are from 8 to 25 g/m², or from 10 to 30 g/m².

The laminates obtained according to the invention, although being thin, have excellent mechanical properties and, in addition, still have high puncture resistance (i.e. resistance to superabsorber grains, e.g. in diapers) and high thermal stabilities (i.e. resistance to hot melt adhesives).

Laminates obtained according to the invention can be further processed in known manner, e.g. to diapers.

FIGS. 1 to 3 show preferred embodiments for production of printed laminates, with FIGS. 2 and 3 relating to breathable laminates. In all figures, the reference numeral 1 designates the starting film web to be printed and coated with adhesion promoter, and the reference numeral 2 designates the starting nonwoven web.

FIG. 1 shows an embodiment of the method according to the invention. According to FIG. 1, a starting film web is fed to an eight-color printing unit having printing units 3 and 5 and the central printing cylinder 4. Via the printing units 3, seven colors and, thus, a seven-colored print motif (with any printing ink coverage) as well as, via the printing unit 5, the adhesion promoter (at the printed places) can be applied. When using a suitable formulation, it is also possible to apply printing ink and adhesion promoter each simultaneously by means of printing units 3 and 5, enabling the application of eight-colored printing motifs. The film web is then passed onto a heating cylinder 8 via rollers and a deflection and pressure roller 7. Furthermore, a starting nonwoven web 2 is passed onto the heating cylinder 8 via a deflection and pressure roller 6. The heating cylinder 8 or the heating roller 8 is e.g. a non-stick coated steel roller, which is heated to the desired surface temperature by means of heat supply. According to the invention, heating is performed at this place, and the film web is bonded to the nonwoven web to form the laminate. The laminate passes from the heating roller 8 into a cooled roller nip formed by the rollers 9 and 10. The roller 10 is preferably designed as structured or embossing roller, thereby imparting an embossed structure or structured surface to the film web. The roller 9 is preferably a rubber roller. The roller pair 9/10 is preferably water-cooled, e.g. using water of about 10° C. The laminate is suddenly cooled and embossed in the cooled roller nip. Downstream of the roller pair 9/10, the laminate can be directly taken off, or it can be fed to a ring rolling system 13, 14 via deflection rollers 11 and 12. Then, the finished laminate can be further processed in a manner known per se.

FIG. 2 shows a preferred embodiment for producing printed laminates which can be breathable. A starting film web 1 passes over a stretching unit having rollers 3, 4 and 5, whereby it is stretched. In case that the starting film web is filled, it becomes breathable. Then, the stretched film is fed, as stretched film web 8, to a two-color printing unit having printing units 9 and 11 and the central printing cylinder 10 via deflection rollers 6 and 7. A color can be applied via the printing unit 9, and thus the film can be printed with a single-colored print motif with any printing ink coverage, while the printing unit 11 applies the adhesion promoter over the printed areas. When using a suitable formulation, it is also possible to apply printing ink and adhesion promoter each at the same time by means of printing units 9 and 11, enabling the application of two-colored printing motifs. Then, the film web is passed onto a heating cylinder 14 via rollers and a deflection and pressure roller 13. Furthermore, a starting nonwoven web 2 is passed onto the heating cylinder 14 via a deflection and pressure roller 12. The heating cylinder 14 or the heating roller 14 is e.g. a non-stick coated steel roller, which is heated to the desired surface temperature by means of heat supply. According to the invention, heating is performed at this place, and the film web is bonded to the nonwoven web to form the laminate. The laminate passes from the heating roller 14 into a cooled roller nip formed by the rollers 15 and 16. The roller 16 is preferably designed as structured or embossing roller, thereby imparting an embossed structure or structured surface to the film web. The roller 15 is preferably a rubber roller. The roller pair 15/16 is preferably water-cooled, e.g. using water of about 10° C. The rollers 15 and 16 forming the cooling nip are driven in such a manner that the velocity is substantially the same velocity as compared to the web velocity of the heating roller 14. The laminate is suddenly cooled and embossed in the cooled roller nip. Downstream of the roller pair 15/16, the laminate can be directly taken off, or it can be fed to a ring rolling system 19, 20 via deflection rollers 17 and 18. Then, the finished laminate can be further processed in a manner known per se.

FIG. 3 shows another embodiment of the method of FIG. 2, wherein the film is printed using an eight-color printing unit 9, 10, 11 instead of a two-color printing unit 9, 10, 11. In the printing unit shown in FIG. 2, via the printing units 9, seven colors and, thus, a seven-colored print motif (with any printing ink coverage) as well as, via the printing unit 11, the adhesion promoter can be applied. When using a suitable formulation, it is also possible to apply printing ink and adhesion promoter each simultaneously by means of printing units 9 and 11, enabling the application of eight-colored printing motifs. Otherwise, same reference numerals in FIG. 2 and FIG. 3 designate the same.

The invention enables the production of thin, printed nonwoven film laminates having high coverages of printed areas. The laminates can be variously used. The laminates are used in the hygiene or medical area, e.g. as a laundry protection film, or generally as liquid-impermeable barrier layer. Possible further uses are technical applications, e.g. as roof underlayment.

1. A method for producing a printed nonwoven film laminate from a starting film web of a thermoplastic polymer material and a starting nonwoven web, wherein the melting point of the starting nonwoven web is above the crystallite melting point of at least one component of the polymer material of the starting film web, the method comprising the following steps:
at least partially coating the starting film web with a printing ink and with an adhesion promoter;
heating the coated film web together with the starting nonwoven web to a temperature which is above the crystallite melting point of the at least one component of the polymer material of the starting film web and of the adhesion promoter and below the crystallite melting point of the starting nonwoven web, to obtain a laminate; and
cooling the laminate obtained through a cooled roller nip.

2. The method according to claim 1, characterized in that a starting film web having 15 to 85% by weight of low-melting polymer component and 85 to 15% by weight of high-melting polymer component, based on 100% by weight of low-melting and high-melting polymer components, is used.

3. The method according to claim 1, characterized in that a starting film web and a starting nonwoven web, each having at least one polyethylene or each having at least one polypropylene, are used.

4. The method according to claim 1, characterized in that the starting nonwoven web contains fibers based on polyethylene and/or polypropylene.

5. The method according to claim 1, characterized in that at least 10%, of the starting film web is coated with the printing ink and with the adhesion promoter.

6. The method according to claim 1, characterized in that the printing ink contains pigments, binders, and solvents.

7. The method according to claim 1, characterized in that the adhesion promoter comprises a thermoplastic polymer on water-basis or solvent-basis.

8. The method according to claim 1, characterized in that a printing ink containing the adhesion promoter is used.

9. The method according to claim 1, characterized in that the heating takes place to 5 to 20° C. below the crystallite melting point of the starting nonwoven web.

10. The method according to claim 1, characterized in that the laminate in the cooled roller nip is subjected to cooling to at least 10 to 30° C. below the crystallite melting point of the at least one component of the polymer material of the starting film web.

11. The method according to claim 1, characterized in that a starting film web containing 1 to 75% by weight of filler is used.

12. The method according to claim 1, characterized in that the starting film web has been stretched in machine direction, or cross direction, or both in machine and cross directions.

13. A printed nonwoven film laminate, obtainable by a process according to claim 1.

14. The printed nonwoven film laminate according to claim 13, having a basis weight in the range of from 10 to 45 g/m².

15. (canceled)

16. The method according to claim 1, characterized in that at least 15% of the starting film web is coated with the printing ink and with the adhesion promoter.

17. The method according to claim 1, characterized in that at least 20% of the starting film web is coated with the printing ink and with the adhesion promoter.

18. The method according to claim 1, characterized in that the printing ink is water-based or ethanol-based.

19. The method according to claim 1, characterized in that the adhesion promoter comprises an ethylene-vinyl acetate copolymer (EVA) or polyamide as a polymer.

20. The method according to claim 1, characterized in that a starting film web containing 50 to 75% by weight of filler is used, wherein the filler is chalk.

21. A printed nonwoven film laminate, obtainable by a process according to claim 8.
